(19) United States
(12) Patent Application Publication
(10) Pub. No.: US 2011/0253951 A1
(43) Pub. Date: Oct. 20, 2011

(54) COMPOSITIONS FOR LOW REFRACTIVE-INDEX FILMS

(75) Inventors: Toru YOSHIDA, Yamaguchi (JP); Yasukazu KISHIMOTO, Tokyo (JP)

(73) Assignee: TOSOH F-TECH, INC., Shunan-city (JP)

(21) Appl. No.: 12/830,799

(22) Filed: Jul. 6, 2010

(30) Foreign Application Priority Data
Apr. 16, 2010 (JP) PCT/JP2010/056824

(51) Int. Cl. F21V 9/06

(52) U.S. Cl. 252/589

(57) ABSTRACT

The present invention relates to a composition for low-refractive-index films, components (b) and (c), and an organic solvent. Component (b) is a fluorine-containing polymer. Component (c) is one or more of acrylic acid derivatives and methacrylic acid derivatives having 1 to 5 acryloyl groups or methacryloyl groups. Component (b) is a copolymer comprising 10 to 50 parts by mole of one or more of fluorine-containing polymers having cyclic structures as represented by formulae (1), (2) and (3), and tetrafluoroethylene; 0 to 50 parts by mole of hexafluoropropylene; 90 to 10 parts by mole of vinylidene fluoride; and 10 to 100 parts by mole of vinyl fluoride and component (b) is one or more of methacrylate compounds and acrylate compounds containing a fluoroalkyl group having 1 to 10 carbon atoms.

### TECHNICAL FIELD

The present invention relates to a composition for forming a fluorine-containing low-refractive-index film, which is coated on the surface of an application substrate thereby eliminating or reducing reflections.

### BACKGROUND ART

So far, antireflection coatings have been applied to various displays, optical products, vehicles' windows, etc. In recent years, attention has been paid to photovoltaic power generation systems, yet photoelectric transformation (photovoltaic) efficiency has still remained insufficient; enhancing power generation efficiency is still a significant challenge to the art. Power generation efficiency is known to be enhanced not only by improving the performance of a photoelectric transformation (photovoltaic) device that forming part of a generator but also by an optical system located before the photoelectric transformation device. For the optical system matter, there have been a good deal of attempts where reflection of light at the surface is reduced to introduce more light in the optical system thereby boosting up power generation, and one of them is antireflection coating now under study.

For such antireflection coating, magnesium fluoride (MgF₂) films have generally been used as a low-refractive-index thin-film material because of having a low refractive index and being excellent in durability, as set forth typically in JP(A) 8-53631 (Patent Publication 1). However, MgF₂ films are still poor in sticking or bonding strength and hardness and scratch resistance as well; they are still far away from practicality because they must be baked to glass articles but cannot be baked to plastic articles.

As materials whose refractivity is as low as that of MgF₂, for instance, there are fluorine-containing polymers such as polytetrafluoroethylene; however, they have much difficulty being formed into a thin film because it is poor in processability on molding and insoluble in general solvents. Referring again to the thin-film formation using a fluorine-containing polymer that is soluble or dispersible in solvents as disclosed in Patent Publication 1, there have been practical problems caused by low adhesion, phase separation, etc.

Having for its object the provision of a novel component that can have a properly selected refractive index and yield a cured product having good adhesion to an optical part at a low refractive index, JP(A) 2002-332313 (Patent Publication 2) discloses a composition comprising a perfluoroalkyl group-containing prepolymer that is a copolymer of a perfluoroalkyl group-containing (meth)acrylate and a cross-linkable, functional group-containing (meth)acrylic acid derivative.

As the fluoroalkyl ester of methacrylic acid or acrylic acid turns into a component for organic materials such as polymers, it can easily give just only low refractivity but also processability and coatability to them, but it is still less than satisfactory in terms of practical applications because of limited mechanical strength.

### CITATION LIST

### Patent Literature

Patent Publication 1: JP(A) 8-53631
Patent Publication 2: JP(A) 2002-332313

### SUMMARY OF INVENTION

### Technical Problem

A primary object of the invention is to provide a composition for low-refractive-index films, with which a low-refractive-index film excellent in adhesion to an application substrate and strength can be obtained easily by a simplified process.

### Solution to Problem

According to the invention, the aforesaid object is accomplished by the following embodiments.

(1) A composition for low-refractive-index films, comprising at least either one of the following components (a) and (b), the following component (c), and an organic solvent:

Component (a): one or two or more of methacrylate compounds and acrylate compounds containing a fluoroalkyl group having 1 to 10 carbon atoms,

Component (b): a fluorine-containing polymer, and

Component (c): one or two or more of acrylic acid derivatives and methacrylic acid derivatives having 1 to 5 acryloyl groups or methacryloyl groups.

(2) The composition for low-refractive-index films according to (1) above, which contains said components (b) and (c) in an amount of 0.1 to 50 parts by mass (by weight) and 1 to 50 parts by mass (by weight), respectively.

(3) The composition for low-refractive-index films according to (1) above, which comprises both said components (a) and (b), and wherein said components (a), (b) and (c) are contained in an amount of 1 to 90 parts by mass (by weight), 0.1 to 50 parts by mass (by weight), and 1 to 50 parts by mass (by weight), respectively.

(4) The composition for low-refractive-index films according to any one of (1) to (3) above, which further contains fumed silica as a component (d).

(5) The composition for low-refractive index films according to (4) above, wherein said component (d) is contained in an amount of 0.01 to 10 parts by mass (by weight).

(6) The composition for low-refractive-index films according to (4) or (5) above, wherein said components (a) and (c) are contained in an amount of 1 to 90 parts by mass (by weight) and 1 to 50 parts by mass (by weight), respectively.

(7) The composition for low-refractive-index films according to (1) to (5) above, which further contains a polymerization initiator.

(8) The composition for low-refractive-index films according to (1) to (7) above, wherein said component (b): fluorine-containing polymer is a copolymer comprising 10 to 50 parts by mole of one or two or more of fluorine-containing polymers having cyclic structures represented by the following formulae (1), (2) and (3) and tetra-fluoroethylene:

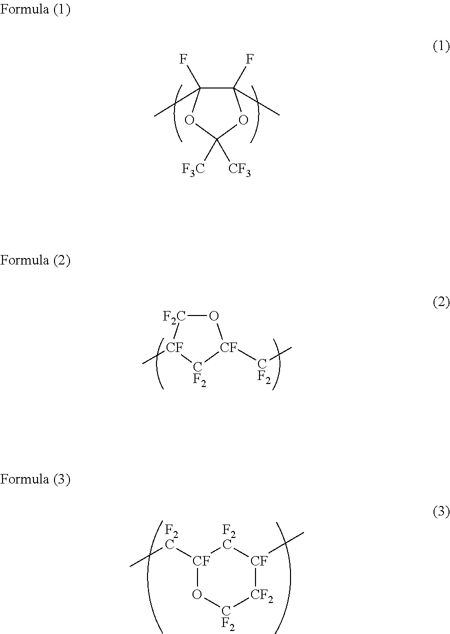

0 to 50 parts by mole of hexafluoropropylene, 90 to 10 parts by mole of vinylidene fluoride, and 10 to 100 parts by mole of vinyl fluoride.

(9) The composition for low-refractive-index films according to any one of (1) to (7) above, wherein said component (b): fluorine-containing polymer is one or two or more of methacrylate compounds and acrylate compounds containing a fluoroalkyl group having 1 to 10 carbon atoms.

(10) The composition for low-refractive-index films according to any one of (1) and (3) to (9) above, wherein said component (a): methacrylate compounds and acrylate compounds containing a fluoroalkyl group having 1 to 10 carbon atoms is 2,2,2-trifluoroethyl methacrylate and/or 2,2,2-trifluoroethyl acrylate.

### ADVANTAGEOUS EFFECTS OF INVENTION

According to the invention, it is possible to form a low-refractive film having antireflection effect, which can be produced readily by a simplified method and has improved adhesion to an application substrate and high mechanical strength.

### DESCRIPTION OF EMBODIMENTS

The inventive composition for low-refractive-index films comprises at least either one of the following components (a) and (b), the following component (c), and an organic solvent:

Component (a): one or two or more of methacrylate compounds and acrylate compounds containing a fluoroalkyl group having 1 to 10 carbon atoms,

Component (b): a fluorine-containing polymer, and

Component (c): one or two or more of acrylic acid derivatives and methacrylic acid derivatives having 1 to 5 acryloyl groups or methacryloyl groups. That composition may further contain fumed silica as a component (d).

With a polymerization initiator added to such a composition, it is polymerized and cured by application to it of energy such as light, radiations, heat or the like, so that a low-refractive-index film composition can be very easily obtained.

In the invention, the component (a): fluoroalkyl group-containing methacrylate compounds or acrylate compounds, and the component (b): fluorine-containing compounds such as fluorine-containing polymers take a chief role of bringing down the refractive index of the ensuing thin-film composition. On the other hand, the component (c): acrylic acid derivatives and methacrylic acid derivatives having 1 to 5 acryloyl groups or methacryloyl groups, and the component (d): fluorine-free compounds such as fumed silica make improvements in the hardness, scratch resistance, and adhesion to an application substrate, of the ensuing thin-film composition. Thus, if these components are combined into a composition, it is then possible to obtain an improved antireflection film having the combined properties of the former and the latter.

There is no particular limitation on how to combine the respective components if the composition contains either one of the components (a) and (b), the component (c) and the organic solvent, optionally with the component (d). However, combinations of the components (b) and (c), and all the components (a), (b) and (c) are preferred, and a combination of the components (a) and (c) with the component d) is preferred as well.

The respective components should preferably be contained in the following quantitative ranges.

### Component (a)

The methacrylate compound and/or the acrylate compound, each containing a fluoroalkyl group having 1 to 10 carbon atoms, should be contained in an amount of preferably 1 to 90 parts by mass (by weight), more preferably 50 to 90 parts by mass (by weight), and even more preferably 70 to 90 parts by mass (by weight).

### Component (b)

The fluorine-containing polymer should be contained in an amount of preferably 0.1 to 50 parts by mass (by weight), more preferably 0.5 to 50 parts by mass (by weight), and even more preferably 1 to 50 parts by mass (by weight).

### Component (c)

The acrylic acid derivative and/or the methacrylic acid derivative, each containing 1 to 5 acryloyl groups or methacryloyl groups, should be contained in an amount of preferably 1 to 50 parts by mass (by weight), more preferably 1 to 30 parts by mass (by weight), and even more preferably 1 to 25 parts by mass (by weight).

### Component (d)

Fumed silica should be contained in an amount of preferably 0.1 to 10 parts by mass (by weight), more preferably 0.01 to 8 parts by mass (by weight), and even more preferably 0.01 to 5 parts by mass (by weight).

### Component (a)

By way of example but not by way of limitation, the methacrylate compounds and/or acrylate compounds containing a fluoroalkyl group having 1 to 10, preferably 2 to 10, carbon atoms include CF₃(CF₂)₈CH₂O₂CCH═CH₂, CF₃ (CF₂)₈CH₂O₂CC(CH₃)═CH₂, HCF₂ (CF₂)₇ (CH₂)₂O₂CCH═CH₂, HCF₂ (CF₂)₇ (CH₂)₂O₂CC(CH₃)═CH₂, CF₃ (CF₂)₇CH₂O₂CCH═CH₂₁ CF₃ (CF₂)₇CH₂O₂CC(CH₃)═CH₂, CF₃ (CF₂)₇CH₂O₂CCH═CH₂, CF₃ (CF₂)₆CH₂O₂CC(CH₃)═CH₂, CF₃ (CF₂)₅CH₂O₂CCH═CH₂, CF₃ (CF₂)₅CH₂O₂CC(CH₃)—CH₂, CF₃ (CF₂)₄—CH₂O₂CCH═CH₂, CF₃ (CF₂)₄—CH₂O₂CC(CH₃)═CH₂, CF₃ (CF₂)₃CH₂O₂CCH═CH₂, CF₃ (CF₂)₃CH₂O₂CC(CH₃)═CH₂, CF₃ (CF₂)₂CH₂O₂CCH═CH₂, CF₃ (CF₂)₂CH₂O₂CC(CH₃)═CH₂, (CF₃)₃CCH₂O₂CCH═CH₂, (CF₃)₃CCH₂O₂CC(CH₃)═CH₂, (CF₃)₂CFCH₂O₂CCH═CH₂, (CF₃)₂CFCH₂O₂CC(CH₃)—CH₂, CF₃CF₂CH(CF₃)O₂CCH═CH₂, CF₃CF₂CH(CF₃)O₂CC(CH₃)═CH₂, CF₃CF₂CH₂O₂CCH═CH₂, CF₃CF₂CH₂O₂CC(CH₃)═CH₂, CF₃CF₃CHO₂CCH═CH₂, CF₃CF₃CHO₂CC(CH₃)═CH₂, H₂CFCH₂O₂CCH═CH₂, H₂CFCH₂O₂CC(CH₃)═CH₂, HCF₂CH₂O₂CCH═CH₂, HCF₂CH₂O₂CC(CH₃)═CH₂, CF₃CH₂O₂CCH═CH₂, and CF₃CH₂O₂CC(CH₃)═CH₂, which may be used alone or in admixture of two or more. Among others, 2,2,2-trifluoroethyl methacrylate: CF₃CH₂O₂CCH═CH₂, and 2,2,2-trifluoroethyl acrylate: CF₃CH₂O₂CC(CH₃)═CH₂ is particularly preferred.

### Component (c)

By way of example but not by way of limitation, the acrylic acid derivative and/or methacrylic acid derivative having 1 to 5 acryloyl groups or methacryloyl groups should preferably be free of fluorine. By combination with the fluorine-free acryloyl (methacryloyl) compound, there can be mechanical properties improved.

By way of example but not by way of limitation, such acrylic acid derivatives and/or methacrylic acid derivatives include CH₂O₂CC(CH₃)═CH₂; CH₂O₂CCH═CH₂; commercial products made and sold by Shin-Nakamura Chemical Co., Ltd., and Nippon Kayaku Co., Ltd. such as CH₂OC(CH₃)O₂C(CH₂O)COC(CH₃)—CH₂, CH₂═C(CH₃)O₂C(CH₂O)₂COC(CH₃)═CH₂, CH₂═C(CH₃)O₂C(CH₂O)₃COC(CH₃)═CH₂, CH₂═C(CH₃)O₂C(CH₂O)₄COC(CH₃)═CH₂, CH₂═CHO₂C(CH₂O)₄COCH═CH₂, CH₂—CHO₂C(CH₂O)₆COCH═CH₂, CH₂═CHO₂C(CH₂O)₉COCH═CH₂, CH₂—CHO₂C(CH₂O)₁₀COCH═CH₂, CH₂═C(CH₃)O₂C(CH₂O)₉COC(CH₃)—CH₂, CH₂═C(CH₃)O₂C(CH₂O)₁₄COC(CH₃)═CH₂, CH₂═C(CH₃)O₂C(CH₂O)₂₃COC(CH₃)═CH₂, CH₂═C(CH₃)O₂CCH₂C(CH₃)₂CH₂CO₂C(CH₃)═CH₂, CH₂═CHO₂CCH₂C(CH₃)₂CH₂CO₂CH═CH₂CH₂═C(CH₃) O₂CCH₂CH(OH)CH₂CO₂C(C H₃)═CH₂, CH₂═C(CH₃)O₂C(CH₂)₉CO₂C(CH₃)═CH₂, CH₂═C(CH₃)O₂C(CH₂O)ₘ(C₆H₄C(CH₃)₂C₆H₄) (CH₂O)ₙCOC(CH₃)═CH₂ (m+n=2 to 30), CH₂═CHO₂C(CH₂O)ₘ(C₆H₄C(CH₃)₂C₆H₄) (CH₂O)ₙCOCCH═CH₂ (m+n=2 to 30), tricyclodecanedimethanol dimethacrylate, tricyclodecanedimethanol diacrylate, CH_{2═C(CH}₃)O₂C(CH₂C(C₂H₅) (CH₂O₂CC(CH₃)═CH₂)CH₂)O₂CC(CH₃)═CH₂, CH₂═CHO₂C(CH₂C(C₂H₅)(CH₂O₂CCH═CH₂)CH₂)O₂CCH═CH₂, CH₂═CHO₂C(CH₂C(CH₂O₂CCH═CH₂)₂CH₂)O₂CCH═CH₂, and CH₂═CHO₂C(CH₂C(CH₂O₂CCH═CH₂)₂CH₂)OCH₂C(CH₃)₂ (CH₂O₂CCH═CH₂)₂; commercial products made and sold by Tokushiki Co., Ltd., Shin-Nakamura Chemical Co., Ltd. or Nippon Kayaku Co., Ltd. such as urethane dimethacrylate compounds or urethane diacrylate compounds having an urethane skeleton; and urethane dimethacrylate compounds, urethane diacrylate compounds, and urethane methacrylate acrylates derived from Karenz Series that are isocyanate monomers sold by Showa Denko Co., Ltd. These may be used alone or in admixture of two or more.

### Component (d)

The inventive composition may further contain fumed silica as necessary. By incorporation of fumed silica, the refractive index and other performances of the obtained film can be improved. This is particularly effective for the aforesaid combination of the components (a) and (c). The fumed silica that may be used herein has a primary particle average diameter of preferably 1 to 100 nm, and more preferably 3 to 50 nm, and a specific surface area (Sm=S/ρV where S is the surface area, ρ is the density, and V is the volume) of preferably 10 to 1,000 m²/g, and more preferably 40 to 400 m²/g. Note here that the specific surface area is usually measured by the gas adsorption method (BET), the permeability method or the like. For the fumed silica products sold by Evonik Ltd. for instance, there may be the mention of R202, R805, R812, R812S, RX200, RY200, R972, R972CF, 90G, 200V, 200CF, 200FAD, and 300CF, and that fumed silica may be used with finely divided titania, zirconia, alumina, silica-alumina, etc. that may be used alone or in admixture of two or more. The amount of such materials mixed with fumed silica may be selected from a range without detrimental to the function of the aforesaid main components.

### Component (b)

While there is no particular limitation placed on the fluorine-containing polymer used in the invention, yet it must be soluble or dispersible in the organic solvent. In particular, preference is given to the fluorine-containing polymers having cyclic structures represented by the following formulae (1), (2), (3) and/or copolymers of monomers: tetrafluoroethylene, hexa-fluoropropylene, vinylidene fluoride, and vinyl fluoride.

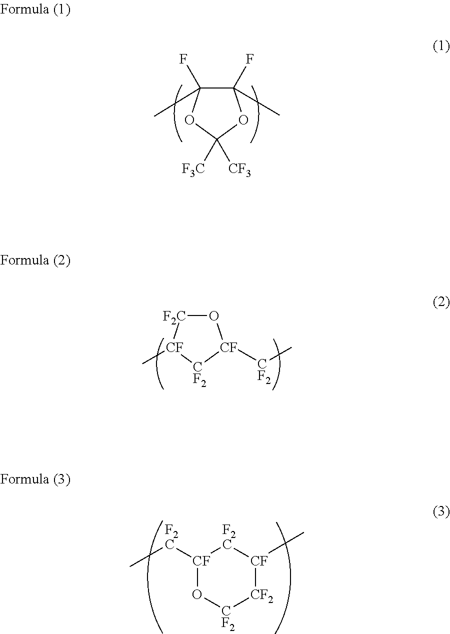

The respective monomers should preferably have the following content ranges:

10 to 50 parts by mole, preferably 10 to 45 parts by mole, and more preferably 10 to 40 parts by mole of Fluorine-containing polymer having cyclic structures represented by formulae (1) to (3) and/or tetrafluoroethylene, 0 to 50 parts by mole, preferably 0 to 45 parts by mole, and more preferably 0 to 40 parts by mole of hexafluoro-propylene, 90 to 10 parts by mole, preferably 85 to 10 parts by mole, and more preferably 80 to 10 parts by mole of vinylidene fluoride, and 10 to 100 parts by mole, preferably 15 to 100 parts by mole, and more preferably 20 to 100 parts by mole of vinyl fluoride.

The aforesaid fluorine-containing polymers are commercially available and, for instance, there may be the mention of Teflon (registered trademark) AF Series (Du Pont), Fluon Series (Asahi Glass Co., Ltd.), Hiflon Series (Solvay S.A.), Cytop (Asahi Glass Co., Ltd.), THV Series (Sumitomo 3M Co., Ltd.), Neoflon Series (Daikin Industries, Ltd.), Kynar Series (Alkema), Tedorar Series (Du Pont), and Dyneon Series (Dyneon Co., Ltd.). These may be used alone or in admixture of two or more.

For the fluorine-containing polymer that may be used herein, use may further be made of polymers comprising the methacrylate compounds and/or acrylate compounds, each containing a fluoroalkyl group having 1 to 10 carbon atoms, as exemplified as the aforesaid component (a). Particular preference is given to a polymer obtained by thermal polymerization of one, or a mixture of two or more, of the compounds exemplified as the component (a), and for the preferable component (a), see above. These polymers should have a number-average molecular weight of preferably 5,000 to 3,000,000, more preferably 5,000 to 2,000,000, and even more preferably 5,000 to 1,500,000, as calculated on a polystyrene basis (that is, when polystyrene is used as the polymer), and other polymers too should have such a number-average molecular weight in a molecular ratio to polystyrene.

If the organic solvent used here allows the aforesaid fluorine-containing polymer to be soluble or dispersible in it, there is no particular limitation on it. Specifically, there are fluoroalcohol base solvents such as CF₃CH₂OH, F(CF₂)₂CH₂OH, (CF₃)₂CHOH, F(CF₂)₃CH₂OH, F(CF₂)₄C₂H_{S}OH, H(CF₂)₂CH₂OH, H(CF₂)₃CH₂OH, and H(CF₂)₄CH₂OH; fluorine-containing aromatic solvents such as perfluoro-benzene, and m-xylenehexafluoride; and fluorocarbon base solvents such as CF₄(HFC-14), CHClF₂(HCFC-22), CHF₃(HFC-23), CH₂CF₂(HFC-32), CF₃CF₃(PFC-116), CF₂ClCFCl₂(CFC-113), C₃HClF₅(HCFC-225), CH₂FCF₃(HFC-134a), CH₃CF₃(HFC-143a), CH₃CHF₂(HFC-152a), CH₃CCl₂F(HCFC-141b), CH₃CClF₂(HCFC-142b), and C₄F₈(PFC-C318).

There are also hydrocarbon base solvents such as xylene, toluene, Solvesso 100, Solvesso 150, and hexane; ester base solvents such as methyl acetate, ethyl acetate, butyl acetate, acetic acid ethylene glycol monomethyl ether, acetic acid ethylene glycol monoethyl ether, acetic acid ethylene glycol monobutyl ether, acetic acid diethylene glycol monomethyl ether, acetic acid diethylene glycol monoethyl ether, acetic acid diethylene glycol monobutyl ether, acetic acid ethylene glycol, and acetic acid diethylene glycol; ether base solvents such as dimethyl ether, diethyl ether, dibutyl ether, ethylene glycol monomethyl ether, ethylene glycol monoethyl ether, ethylene glycol monobutyl ether, ethylene glycol dimethyl ether, ethylene glycol diethyl ether, ethylene glycol dibutyl ether, diethylene glycol monomethyl ether, diethylene glycol monoethyl ether, diethylene glycol monobutyl ether, diethylene glycol dimethyl ether, diethylene glycol diethyl ether, diethylene glycol dibutyl ether, and tetrahydrofuran; ketone base solvents such as methyl ethyl ketone, methyl isobutyl ketone, and acetone; amide base solvents such as N,N-dimethylacetoamide, N-methylacetoamide, acetoamide, N,N-dimethylformamide, N,N-diethylformamide, and N-methylformamide; sulfonic acid ester base solvents such as dimethylsulfoxide; methanol; ethanol; isopropanol; butanol; ethylene glycol; diethylene glycol; and polyethylene glycol (having a polymerization degree of 3 to 100). These solvents may be used alone or in admixture of two or more.

It is here noted that among the aforesaid solvents, preference is given to the fluorine base solvents, ketone base solvents and ester base solvents in consideration of solubility, coated films' appearance, and stability on storage. Particular preference is given to the sole or combined use of methyl ethyl ketone, methyl isobutyl ketone, cyclohexanone, Cellosolve acetate, butyl acetate, ethyl acetate, perfluorobenzene, m-xylenehexafluoride, HCFC-225, CFC-113, HFC-134a, HFC-143a, and HFC-142b.

No particular limitation is imposed on the polymerization initiator to be added to the inventive composition; selection may be made from polymerization initiators suitable for applications, the desired properties of films, and production processes. However, photo-polymerization initiators are most recommendable. Use of photo-polymerization initiators relying upon UV curing would result in particularly excellent performance. By way of example but not by way of limitation, the photo-polymerization initiators used here include products made by Novartis AG such as IRGACURE 651, IRGACURE 184, DAROCUR 1173, IRGACURE 2959, IRGACURE 127, IIRGACURE 907, IIRGACURE 369, IIRGACURE 379, DAROCUR TPO, IRGACURE 819, IRGACURE 784, IRGACURE OXE1, IRGACURE OXE2, and IRGACURE 754; and Lucirin TPO, and Lucirin TPO-L made by BASF. These initiators may be used alone or in admixture of two or more. By way of example but not by way of limitation, the photo-polymerization initiator should be contained in an amount of preferably 0.1 to 20 parts by mass (by weight), more preferably 0.1 to 15 parts by mass (by weight), and even more preferably 1 to 10 parts by mass (by weight). Other polymerization initiators, when used, may also be used in the aforesaid quantitative range.

For acceleration of photo-curing, photosensitizers, for instance, ketone compounds such as benzophenone, dyes such as rose bengal, and conjugative compounds such as fluorene, pyrene or fullerene may be used in a quantity 0.05 to 3 times, preferably 0.05 to 2 times, and more preferably 0.05 to 1.5 times by mass or by weight as much as the photo-initiator.

For photo-curing according to the invention, thermal initiators capable of generating radicals by heating may be used in a quantity 0.05 to 3 times, preferably 0.05 to 2 times, and more preferably 0.05 to 1.5 times by mass or by weight as much as the photo-initiator, or the photo-initiator may be used with the photosensitizer. The thermal initiators used preferably include compounds such as AIBN (azobisisobutyronitrile), ketone peroxide, peroxyketal, hydroperoxide, diallylkyl peroxide, diacyl peroxide, peroxyester, and peroxycabonate or their derivatives. There may also be commercial products used, for instance, products made by NOF Corporation such as Perloyl O, Perloyl L, Perloyl S, Perocta O, Perloyl SA, Perhexa 250, Perhexyl O, Nyper PMB, Perbutyl O, Nyper BMT, Nyper BW, Perbutyl IB, Perhexa MC, Perhexa TMH, Perhexa HC, Perhexa C, Pertetra A, Perhexyl I, Perbutyl MA, Perbutyl 355, Perbutyl L, Pehrexa 25MT, Perbutyl I, Perbutyl E, Perhexyl Z, Perhexa V, Perbutyl P, Percumyl D, Perhexyl D, Perhexa 25B, Perbutyl D, Permenta H, and Perhexin 25B.

To obtain the end film from the inventive composition, for instance, light is applied to a mixture comprising 1 to 90 parts by mass (by weight) of the methacrylate compound and/or acrylate compound, each containing a fluoroalkyl group having 1 to 10 carbon atoms, 1 to 50 parts by mass (by weight) of the fluorine-free acrylic acid derivative or methacrylic acid derivative having 1 to 5 acryloyl groups or methacryloyl groups, 0.1 to 50 parts by mass (by weight) of the fluorine-containing polymer dissolved or dispersed in the organic solvent and 0.1 to 20 parts by mass (by weight) of the photo-polymerization initiator, thereby obtaining a film-form, low-refractive-index coating layer.

Alternatively, light is applied to a mixture comprising 1 to 50% by mass (by weight) of the fluorine-free acrylic acid derivative or methacrylic acid derivative having 1 to 5 acryloyl groups or methacryloyl groups, 0.1 to 50% by mass (by weight) of the fluorine-containing polymer dissolved or dispersed in the organic solvent and 0.1 to 10% by mass (by weight) of the photo-polymerization initiator, thereby obtaining a film-form, low-refractive-index composition.

Yet alternatively, light is applied to a mixture comprising 1 to 90 parts by mass (by weight) of the methacrylate compound and/or acrylate compound, each containing a fluoroalkyl group having 1 to 10 carbon atoms, 1 to 50 parts by mass (by weight) of the fluorine-free acrylic acid derivative or methacrylic acid derivative having 1 to 5 acryloyl groups or methacryloyl groups, 0.01 to 10 parts by mass (by weight) of fumed silica and 0.1 to 10 parts by mass (by weight) of the photo-polymerization initiator, thereby obtaining a film-form, low-refractive-index composition.

For photo-curing according to the invention, for instance, use may be made of light from high-pressure mercury lamps, constant-pressure mercury lamps, thallium lamps, indium lamps, metal halide lamps, xenon lamps, ultraviolet LED, blue LED, white LED, excimer lamps made by Harison Toshiba Lighting Cooperation, and H bulbs, H Plus blubs, D bulbs, V bulbs, Q bulbs and M bulbs, all made by Fusion Co., Ltd. Sunlight may be used too. When the photo-curing reaction hardly proceeds, it is preferred that light irradiation is implemented in the absence of oxygen. In the presence of oxygen, a film surface remains sticky for a while due to oxygen inhibition; the quantity of the initiator used must be increased. It is here noted that in the absence of oxygen, curing may be implemented in an atmosphere of nitrogen gas, carbon dioxide gas, helium gas or the like.

The quantity of light to be applied may be optional if the photo-polymerization initiator can trigger off radicals in that quantity of light. However, it is noted that in a very low quantity of light, polymerization remains incomplete, rendering the cured product poor in heat resistance and mechanical properties, and in too an excessive quantity of light, on the contrary, the cured product deteriorates due to light such as yellowing. So ultraviolet radiation of, e.g., 200 to 400 nm is applied in a quantity of 0.1 to 200 J/cm² depending on the monomer composition, and the type and amount of the photo-polymerization initiator as well.

There is no particular limitation imposed on how to form the composition into a film; for instance, the film may be formed by means of coating, printing or dipping. The thickness of the ensuing film may be regulated depending on the amount and type of the solvent used and such additives as viscosity increasers and fine particle additives at the film-formation step such as a curing method.

The film composition obtained by the invention is characterized by having a refractive index to light at sodium D line (589 nm) of greater than 1.30 to less than 1.50, preferably greater than 1.31 to less than 1.49, and more preferably greater than 1.33 to less than 1.49.

By way of example but not by way of limitation, the invention is now explained more specifically with reference to the following examples.

### EXAMPLES

For photo-curing, a high-pressure mercury lamp made by Harison Toshiba Lighting Cooperation or an H bulb made by Fusion Co., Ltd. was used as a light source. The actinometer used was UV POWER PUCK made by EIT Co., Ltd. The refractive index was measured at 23° C. and 589 nm wavelength (D line) with M-150 made by JASCO; the film thickness was measured with PG-20 made by Teclock Co., Ltd.; and the pencil hardness was measured with KT-VF2391 made by Cotec Co., Ltd.

Photo-curing was determined by tack-free testing (touch testing). That is, the curing time is defined as a period of time by the time the surface tackiness of the photo-curable composition obtained by light irradiation is removed off.

### Example 1

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 100 mg of IRGACURE 184 made by Novartis AG and 5 mg of R202 made by Evonik Ltd. (fumed silica treated with dimethyl silicon oil), and the mixture was stirred until it was visually found to become uniform. A part (54.3 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent thin film was obtained. Note here that the composition solution, because of having a sufficiently low viscosity, dropped into a uniform film (the same will hold for the following examples). The thin film had a thickness of 8 μm, a pencil hardness of 5H, and a refractive index of 1.44.

### Example 2

Nine (9.0) grams of 2,2,2-trifluoroethyl acrylate made by Osaka Organic Chemical Industry Ltd. and 1.0 gram of KAYA-R684 (tricyclodecanedimethanol diacrylate) made by Nippon Kayaku Co., Ltd. were mixed with 100 mg of IRGACURE 184 made by Novartis AG and 5 mg of R202 made by Evonik Ltd. (fumed silica treated with dimethyl silicon oil), and the mixture was stirred until it was visually found to become uniform. A part (40.4 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lightings Co., Ltd. for about 1 second (320 nm to 390 nm, 500 mJ/cm²), whereupon a stickiness-free transparent thin film was obtained. The thin film had a thickness of 9 μm, a pencil hardness of 5H and a refractive index of 1.43.

### Example 3

Nine (9.0) grams of 2,2,2-trifluoroethyl meth-acrylate made by Tosoh E-Tech Inc. and 1.0 gram of NK—NOD (1,9-nonanediol dimethacrylate) made by Shin-Nakamura Chemical Co., Ltd. were mixed with 200 mg of IRGACURE 184 made by Novartis AG and 5 mg of R202 made by Evonik Ltd. (fumed silica treated with dimethyl silicon oil), and the mixture was stirred until it was visually found to become uniform. A part (54.3 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Co., Ltd. for about 1 second (320 nm to 390 nm, 500 mJ/cm²), whereupon a stickiness-free transparent thin film was obtained. The thin film had a thickness of 8 μm, a pencil hardness of H and a refractive index of 1.44.

### Example 4

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 100 mg of NK-701 (2-hydroxy-1,3-dimethacryloylmethane) made by Shin-Nakamura Chemical Co., Ltd., 200 mg of IRGACURE 127 made by Novartis AG and 5 mg of R202 made by Evonik Ltd. (fumed silica treated with dimethyl silicon oil), and the mixture was stirred until it was visually found to become uniform. A part (47.5 mg) of the obtained solution was passed by a pipette over a glass sheet made by Matsunami Glass Ind. Ltd. (50 mm×40 mm×0.1 mm), and the composition on that glass sheet was irradiated with light from an H bulb made by Fusion Co., Ltd. for about 1 second (320 nm to 390 nm, 500 mJ/cm²), whereupon a stickiness-free transparent thin film was obtained. The thin film had a thickness of 9 μm, a pencil hardness of 4H and a refractive index of 1.42.

### Example 5

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 200 mg of IRGACURE 1173 made by Novartis AG, 10 mg of Kiner SL (Arkema Co., Ltd.) dissolved in 40 ml of MIBK (methyl isobutyl ketone) made by Wako Pure Chemical Industries, Ltd. and 5 mg of R202 made by Evonik Ltd. (fumed silica treated with dimethyl silicon oil), and the mixture was stirred until it was visually found to become uniform. A part (32.7 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lightings Ltd. for about 5 seconds (320 nm to 390 nm, 2,000 mJ/cm²), whereupon a stickiness-free transparent thin film was obtained. The thin film had a thickness of 8 μm, a pencil hardness of H and a refractive index of 1.45.

### Example 6

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 200 mg of IRGACURE 184 made by Novartis AG and 10 mg of Kiner SL (Arkema Co., Ltd.) dissolved in 40 ml of MIBK (methyl isobutyl ketone) made by Wako Pure Chemical Industries, Ltd., and the mixture was stirred until it was visually found to become uniform. A part (49.5 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Ltd. for about 5 seconds (320 nm to 390 nm, 2,000 mJ/cm²), whereupon a stickiness-free transparent thin film was obtained. The thin film had a thickness of 8 μm, a pencil hardness of H and a refractive index of 1.45.

### Example 7

One (1.0) gram of NK-1G (ethylene glycol dimethacrylate) made by Shin-Nakamura Chemical Co., Ltd. was mixed with 20 mg of IRGACURE 651 made by Novartis AG, 1.0 gram of Kiner SL (Arkema Co., Ltd.) dissolved in 4.0 grams of MIBK (methyl isobutyl ketone) made by Wako Pure Chemical Industries, Ltd. and 5 mg of R202 made by Evonik Ltd. (fumed silica treated with dimethyl silicon oil), and the mixture was stirred until it was visually found to become uniform. A part (39.5 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lightings Ltd. for about 5 seconds (320 nm to 390 nm, 2,000 mJ/cm²), whereupon a stickiness-free transparent thin film was obtained. The thin film had a thickness of 8 μm, a pencil hardness of B and a refractive index of 1.45.

### Example 8

One (1.0) gram of BPE-100 (ethoxylated bis-phenol A dimethacrylate) made by Shin-Nakamura Chemical Co., Ltd. was mixed with 20 mg of IRGACURE 651 made by Novartis AG and 1.0 gram of Kiner SL (Arkema Co., Ltd.) dissolved in 4.0 grams of MIBK (methyl isobutyl ketone) made by Wako Pure Chemical Industries, Ltd., and the mixture was stirred until it was visually found to become uniform. A part (35.5 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Ltd. for about 5 seconds (320 nm to 390 nm, 2,000 mJ/cm²), whereupon a stickiness-free transparent thin film was obtained. The thin film had a thickness of 8 μm, a pencil hardness of 2B and a refractive index of 1.45.

### Example 9

Nine (9.0) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123 and 1.0 gram of A-DCP (tricyclodecanedimethanol diacrylate) made by Shin-Nakamura Chemical Co., Ltd. were mixed with 200 mg of IRGACURE 184 made by Novartis AG, 5 mg of R202 made by Evonik Ltd. (fumed silica treated with dimethyl silicon oil) and 250 mL of butyl acetate, and the mixture was stirred until it was visually found to become uniform. A part (54.3 mg) of the obtained solution was passed by a pipette over a glass sheet made by Matsunami Glass Ind. Ltd. (50 mm×40 mm×0.1 mm), and the composition on that glass sheet was irradiated with light from a high-pressure mercury lamp made by Harison Toshiba Lighting Ltd. for about 1 second (320 nm to 390 nm, 500 mJ/cm²), whereupon a stickiness-free transparent thin film was obtained. The thin film had a thickness of 8 μm, a pencil hardness of 5H and a refractive index of 1.43.

### Example 10

Nine (9.0) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123 and 1.0 gram of A-TMM-3L (pentaerythritol triacrylate) made by Shin-Nakamura Chemical Co., Ltd. were mixed with 200 mg of IRGACURE 184 made by Novartis AG, 5 mg of R202 made by Evonik Ltd. (fumed silica treated with dimethyl silicon oil) and 450 mL of diethylene glycol dimethyl ether, and the mixture was stirred until it was visually found to become uniform. A part (54.3 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Ltd. for about 1 second (320 nm to 390 nm, 500 mJ/cm²), whereupon a stickiness-free transparent thin film was obtained. The thin film had a thickness of 8 μm, a pencil hardness of 3H and a refractive index of 1.43.

### Example 11

Four point five (4.5) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123, 4.5 grams of 2,2,2-trifluoro-ethyl methacrylate made by Tosoh F-Tech Inc. and 1.0 gram of A-DCP (tricyclodecanedimethanol diacrylate) made by Shin-Nakamura Chemical Co., Ltd. were mixed with 200 mg of IRGACURE 184, each made by Novartis AG, 5 mg of R202 made by Evonik Ltd. (fumed silica treated with dimethyl silicon oil) and 250 mL of methyl isobutyl ketone, and the mixture was stirred until it was visually found to become uniform. A part (54.3 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Ltd. for about 1 second (320 nm to 390 nm, 500 mJ/cm²), whereupon a stickiness-free transparent thin film was obtained. The thin film had a thickness of 8 μm, a pencil hardness of 5H and a refractive index of 1.43.

### Example 12

Four point five (4.5) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123, 4.5 grams of 2,2,2-trifluoro-ethyl methacrylate made by Tosoh F-Tech Inc. and 1.0 gram of A-DCP (tricyclodecanedimethanol diacrylate) made by Shin-Nakamura Chemical Co., Ltd. were mixed with 200 mg of IRGACURE 184, each made by Novartis AG, 5 mg of R202 made by Evonik Ltd. (fumed silica treated with dimethyl silicon oil) and 300 mL of butyl acetate, and the mixture was stirred until it was visually found to become uniform. A part (54.3 mg) of the obtained solution was passed by a pipette over a glass sheet made by Matsunami Glass Ind. Ltd. (Micro Cover Glass No. 1, 50 mm×40 mm×0.1 mm), and the composition on that glass sheet was irradiated with light from a high-pressure mercury lamp made by Harison Toshiba Lighting Ltd. for about 1 second (320 nm to 390 nm, 500 mJ/cm²), whereupon a stickiness-free transparent thin film was obtained. The thin film had a thickness of 8 μm, a pencil hardness of 5H and a refractive index of 1.43.

### INDUSTRIAL APPLICABILITY

Film compositions obtained by curing the inventive composition could be used as antireflection films for various displays of word processors, computers, TVs, etc., solar batteries, optical parts, window pane surfaces of cars and electric trains, etc.

1-10. (canceled)

11. A composition for low-refractive-index films, comprising components (b) and (c), and an organic solvent:
component (b): a fluorine-containing polymer, and
component (c): one or more of acrylic acid derivatives and methacrylic acid derivatives having 1 to 5 acryloyl groups or methacryloyl groups.
wherein said component (b) is a copolymer comprising 10 to 50 parts by mole of one or more of fluorine-containing polymers having cyclic structures as represented by formulae (1), (2) and (3), and tetrafluoroethylene; 0 to 50 parts by mole of hexafluoropropylene; 90 to 10 parts by mole of vinylidene fluoride; and 10 to 100 parts by mole of vinyl fluoride: 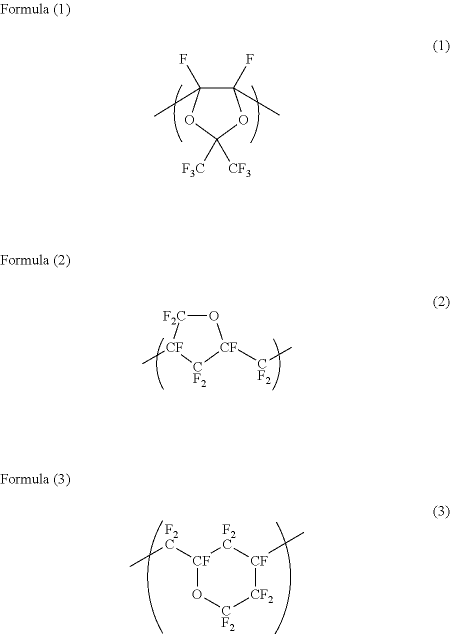
said component (b) is one or more of methacrylate compounds and acrylate compounds containing a fluoroalkyl group having 1 to 10 carbon atoms.

12. The composition for low-refractive-index films according to claim 11, further comprising component (a): one or more of methacrylate compounds and acrylate compounds containing a fluoroalkyl group having 1 to 10 carbon atoms.

13. The composition for low-refractive-index films according to claim 11, wherein said components (b) and (c) are contained in an amount of 0.1 to 50 parts by mass and 1 to 50 parts by mass, respectively.

14. The composition for low-refractive-index films according to claim 12, wherein both said components (a) and (b) are contained, said component (a) being contained in an amount of 1 to 90 parts by mass and said component (b) being contained in an amount of 0.1 to 50 parts by mass, and said component (c) is contained in an amount of 1 to 50 parts by mass.

15. The composition for low-refractive-index films according to claim 11, which further comprises fumed silica as a component (d).

16. The composition for low-refractive-index films according to claim 15, wherein said component (d) is contained in an amount of 0.01 to 10 parts by mass.

17. The composition for low-refractive-index films according to claim 11, which further comprises a polymerization initiator.

18. The composition for low-refractive-index films according to claim 12, wherein the methacrylate compound and acrylate compound containing a fluoroalkyl group having 1 to 10 carbon atoms that is said component (a) are 2,2,2-trifluoro-ethyl methacrylate and/or 2,2,2-trifluoroethyl acrylate.

19. The composition for low-refractive-index films according to claim 13, which further comprises a polymerization initiator
